(19) United States
(12) Patent Application Publication
(10) Pub. No.: US 2006/0056667 A1
(43) Pub. Date: Mar. 16, 2006

(54) Identifying faces from multiple images acquired from widely separated viewpoints

(76) Inventor: Richard C. Waters, Concord, MA (US)

Correspondence Address: Patent Department;Mitsubishi Electric Research Laboratories, Inc., 201 Broadway, Cambridge, MA, 02139, US

(21) Appl. No.: 10/943,185

(22) Filed: Sep. 16, 2004

(51) Int. Cl. G06K 9/00

(52) U.S. Cl. 382/118

(57) ABSTRACT

A method improves facial recognition using pairs of images acquired simultaneously of substantially different portions of faces. By using such pairs, the 3D pose and actual size of the faces can be determined, which enables better normalization and comparison with similar image pairs of identified faces stored in a database.

### FIELD OF THE INVENTION

This patent relates generally to the field of computer vision and pattern recognition, and more particularly to identifying a face based on multiple images.

### BACKGROUND OF THE INVENTION

The most visually distinguishing feature of a person is the face. Therefore, face recognition in still and moving images (videos) is an important technology for many applications where it is desired to identify a person from images. Face recognition and identification presents an extremely difficult challenge for computer vision technology.

For example, in facial images acquired by surveillance cameras, the lighting of a scene is often poor and uncontrolled, and the cameras are generally of low quality and usually distant from potentially important parts of the scene. The location and orientation of the faces in the scene usually cannot be controlled. Some facial features, such as the hairline, eyebrows, and chin are easily altered. Other features, such as the mouth are highly variable, particularly in a video.

Face detection techniques involve the determination of whether or not an image or set of images (as in video) contains a face. Face identification (also known as “face recognition”) compares an image of an unidentified face (a “probe”) with a set of images of identified faces (a “gallery”) to determine possible matches. This comparison permits two possible outcomes: the faces are the same, or are different faces.

Probabilistically, these two outcomes can be expressed as P(SAME|D) and P(DIFFERENT|D), where the datum D represents a pair consisting of a the probe image and an image from the gallery. Using Bayes law, a conditional probability can be expressed as follows:

$$P ( SAME \vert D ) = \frac{P ( D \vert SAME ) P ( SAME )}{P ( D \vert SAME ) P ( SAME ) + P ( D \vert DIFFERENT ) P ( DIFFERENT )}$$

The conditional probability P(DIFFERENT|D) can be expressed similarly, or as=1−P(SAME|D), see Duda et al., “Pattern classification and scene analysis,” Wiley, New York, 1973.

Then, the quantities P(SAME|D) and P(DIFFERENT|D) can be compared to determine whether the probe image is the same as one of the gallery images, or not. To identify a face from among a large number of faces, one maximizes P(SAME|D) over all the images.

Some face identification systems are based on principal component analysis (PCA) or the Karhunen-Loeve expansion. U.S. Pat. No. 5,164,992, “Face Recognition System” issued to M. A. Turk et al. on Nov. 17, 1992 describes a system where a matrix of training vectors is extracted from images and reduced by PCA into a set of orthonormal eigenvectors and associated eigenvalues, which describe the distribution of the images. The vectors are projected onto a subspace. Faces are identified by measuring the Euclidean distance between projected vectors. The problem with the PCA approach is that variations in the appearance of specific features, such as the mouth, cannot be modeled.

Costen et al. in “Automatic Face Recognition: What Representation?” Technical Report of The Institute of Electronics, Information and Communication Engineers (IEICE), pages 95-32, January 1996, describe how using the Mahalanobis distance can raise the accuracy of the identification. A modified Mahalanobis distance method is described by Kato et al. in “A Handwritten Character Recognition System Using Modified Mahalanobis distance,” Transaction of IEICE, Vol. J79-D-II, No. 1, pages 45-52, January 1996. They do this by adding a bias value to each eigenvalue.

Moghaddam et al. describe a probabilistic face recognition in U.S. Pat. No. 5,710,833, “Detection, recognition and coding of complex objects using probabilistic eigenspace analysis” issued on Jan. 20, 1998, and Moghaddam et al., “Beyond eigenfaces: Probabilistic matching for face recognition” Proc. of Int'l Conf. on Automatic Face and Gesture Recognition, pages 30-35, April 1998. They describe a system for recognizing instances of a selected object or object feature, e.g., faces, in a digitally represented scene. They subtract the probe image from each gallery image to obtain a difference image. The distribution of difference images, P(D|SAME) and P(D|DIFFERENT), are then modeled as Gaussian probability density functions.

The key weakness of that method is that the Gaussian models of difference images are very restrictive. In practice two images of the same face can vary with lighting and facial expression, e.g., frowning or smiling. To get useful difference images, the probe and gallery images must be very similar, e.g., a frontal probe image cannot be compared with a profile gallery image of the same face. In addition, their method does not accommodate motion of facial features, such as the mouth, and thus, is not well suited to being used on videos.

Another face recognition technique uses a deformable mapping. Each gallery image is pre-processed to map the gallery image to an elastic graph of nodes. Each node is at a given position on the face, e.g. the corners of the mouth, and is connected to nearby nodes. A set of local image measurements (Gabor filter responses) is made at each node, and the measurements are associated with each node. The probe and gallery images are compared by placing the elastic graph from each gallery image on the probe image.

However, facial features often move as a person smiles or frowns. Therefore, the best position for a node on the probe image is often different than on the gallery image. As an advantage, the elastic graph explicitly handles facial feature motion. However, it is assumed that the features have the same appearance in all images. The disadvantage of that approach is that there is no statistical model for allowed and disallowed variations for same versus different.

Viola and Jones, in “Rapid Object Detection using a Boosted Cascade of Simple Features,” Proceedings IEEE Conf. on Computer Vision and Pattern Recognition, 2001, describe a new framework for detecting objects such as faces in images. They present three new insights: a set of image features which are both extremely efficient and effective for face detection, a feature selection process based on Adaboost, and a cascaded architecture for learning and detecting faces. Adaboost provides an effective learning algorithm and strong bounds on generalized performance, see Freund et al., “A decision-theoretic generalization of on-line learning and an application to boosting,” Computational Learning Theory, Eurocolt '95, pages 23-37. Springer-Verlag, 1995, Schapire et al., “Boosting the margin: A new explanation for the effectiveness of voting methods,” Proceedings of the Fourteenth International Conference on Machine Learning, 1997, Tieu et al., “Boosting image retrieval,” International Conference on Computer Vision, 2000. The Viola and Jones approach provides an extremely efficient technique for face detection but does not address the problem of face recognition, which is a far more complex process.

As has been shown, there are a number of existing systems for identifying a person based on images. The accuracy of most systems is still too low to warrant widespread deployment in security sensitive areas. For example, one system failed to match identities of a test group of employees at Logan International Airport, Boston, Mass., USA in 38% percent of the cases, and machine-generated false positives exceeded 50%. There are a number of factors that contribute to this inaccuracy. These include changes of lighting and perspective that make the images taken of a person look different from the person's image in the database. They also include two key problems stemming from using images from only one perspective.

First, no matter what one perspective is used to produce the image, there are parts of the face that cannot be seen well. A frontal image does not show the sides or profile shape well and a profile image does not show the other side, or the front. This means that automatic recognition systems are using only part of the information that a human would use when recognizing a person.

Second, it is not possible to obtain information about the absolute size of any feature of a face from a single image, unless the exact distance between the face and camera is known. In general this distance is not known and cannot be determined from the image alone. As a result, face recognition systems only use relative sizes of facial features when performing face recognition.

There has been experimentation with face identification based on stereo images, Center et al. “Method of Extending Image-Based Face Recognition Systems to Utilize Multi-View Image Sequences and Audio Information,” U.S. patent application Publication US 2002/0113687. Their stereoscopic system was designed to detect attempts to deceive a face recognition system by distinguishing between images of actual 3D faces and images of 2D representations of faces, for example, detecting an imposter hiding behind a full scale photograph. However, for stereoscopy to work correctly, the optical axes of the multiple cameras need to be substantially parallel, and there needs to be a substantial amount of overlap in the pair of stereo-images. In fact, 3D information is only available for the overlapping portion. That configuration does not help with the first problem noted above, as, for example, facial features that can only be seen in a profile image of the face will not be acquired by a system of cameras arranged to acquire stereo images of a frontal view of a face.

To provide for better security and more accurate identification by images, there is a need for a more accurate face identification system that overcomes the problems above.

### SUMMARY OF THE INVENTION

The invention uses two or more images of an unidentified face acquired from widely separated viewpoints as a basis for face identification. For example, the views can be a frontal view and a right side view, views from the left and right sides, or two ¾ views. In either case, the angle between the cameras is about 90° or greater.

In one embodiment of the invention, two synchronized cameras, the positions of which are known relative to each other, acquire concurrently a frontal view image and a right side view image. After the images are acquired, processing is applied to determine an exact 3D pose of the face. The 3D pose of the face includes a 3D location and 3D orientation. After the 3D pose of the face is determined, it is possible to determine the absolute size of the face using the known values of the positions of the cameras. Given this 3D information, actual dimensions of facial features, such as eyes, nose, mouth, ears, eyebrows, can be determined.

A database contains pairs of frontal and right side images for each face to be recognized, each normalized according to the absolute size of the face. The system compares the pair of images of the unidentified face with the image pairs of the identified faces in the database.

The normalization of the images to a scale defined by the absolute size of the face and features of the face provides significant enhancement to the face recognition system. The system can now distinguish between individuals with similar faces but which differ in size. The prior art methods would normalize each face to a relative scale, and not an absolute size, destroying one of the most distinguishing characteristics of faces, the size.

In addition, the normalization process generates size data, which can be used to order or categorize the faces leading to faster identification.

Furthermore, the use of two images of different views has an important advantage. Two or more views allow much more of the face to be clearly seen than with a single view. For example, an image of a frontal view combined with an image of a right side view, captures details about the right side of the face and the profile shape in addition to frontal information.

The main application of such a system is for access control and person verification. In both of these situations, the observation situation can easily be controlled to accommodate the positioning of two calibrated cameras.

### BRIEF DESCRIPTION OF THE DRAWINGS

FIG. 1 is a block diagram of a system for the identification of a face according to the invention; and

FIG. 2 is a flow diagram of a method for identifying a face based on images from widely separated views according to the invention.

### DETAILED DESCRIPTION OF THE PREFERRED EMBODIMENT

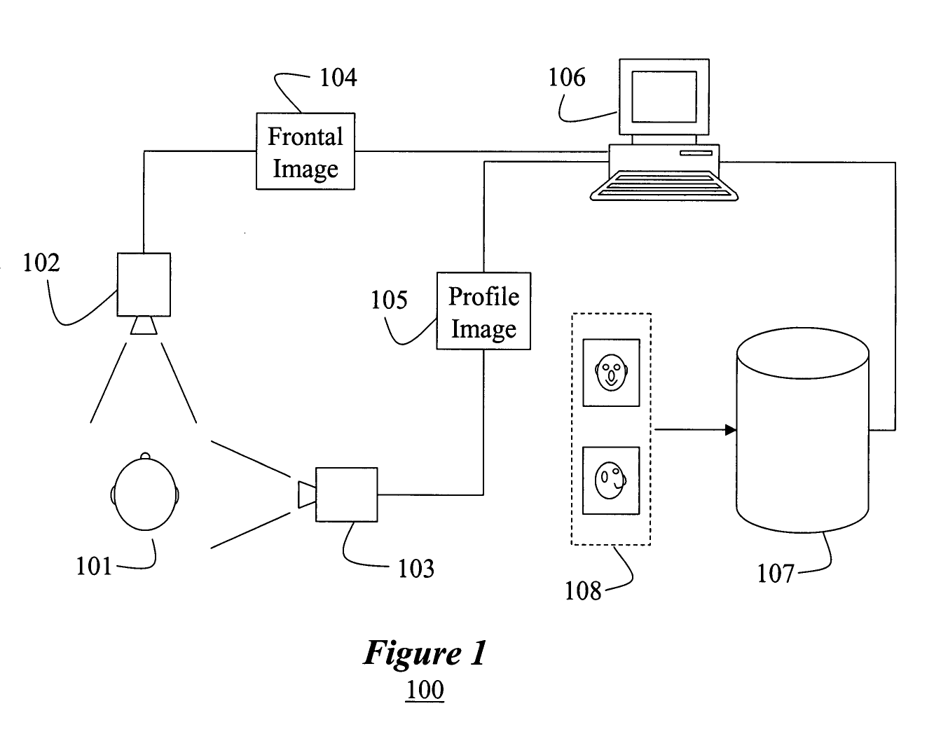

FIG. 1 shows a system 100 for identifying a face according to the invention. A camera 102 acquires a frontal image 104 of an unidentified face 101. A second camera 103 acquires a profile image 105 of the unidentified face. This may be done, for example, by positioning the second camera at a right angle to the first camera, or by positioning the camera to acquire a profile image of the unidentified face from a mirror. The pair of images of the unidentified face is sent to a processor 106, which compares the images of the unidentified face with pairs of images of identified faces 108 stored in a database 107.

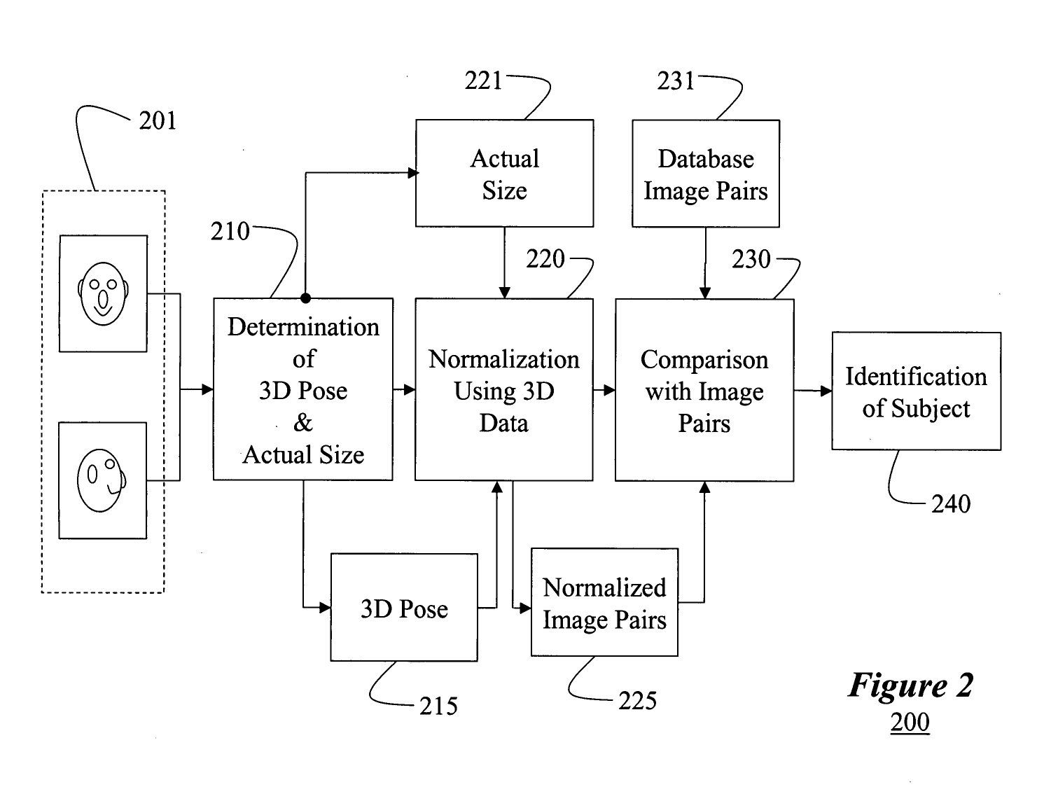

FIG. 2 shows a flow diagram of the method 200 for identifying a face according to the invention. The pair of images of the unidentified face 201 is processed to determine 210 a 3D pose of the unidentified face and its actual size. The 3D pose data 215 and normalization parameters 221, based on the actual size of the faces in the images, are used to normalize 220 the images of the unidentified face to a scale based on the actual size of the face and the same pose as the images of identified faces in the database. The normalized image pair of the unidentified face 225 is then compared 230 with the set of image pairs of identified faces 231 stored in the database 107.

Identification of the unidentified face 240 occurs when a pair of images of an identified face that is substantially similar to the images of the unidentified face is found in the database.

The comparison of the images of the faces can follow the Viola method as described in U.S. patent application Ser. No. 10/200,726 filed on Jul. 22, 2002.

Using machine learning, the scores of the comparisons between the unidentified images and the identified images are weighted to provide the most accurate results for the identification. For example, the frontal view images can be given a greater weight.

In an alternative embodiment, the identified faces are indexed by size parameters of actual features, for example, the distance between the two pupils, the distance from center of ear to tip of nose. This allows the system to very quickly eliminate a large number of faces from comparison, considerably speeding up the identification process.

### EFFECT OF THE INVENTION

The system and method described above provides improved identification of faces in images. By using two images of substantially different portions of an unidentified face, the accuracy of the identification of faces is increased. The processing of the images uses the images to determine a 3D pose and absolute size of the face, which allows for better normalization and comparison with image pairs of identified faces stored in a database.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

I claim:

1. A system for identifying a face, comprising:
a first pair of unidentified images of an unidentified face, the first pair including a first unidentified image and a second unidentified image acquired simultaneously, and a first unidentified portion of the unidentified face in the first unidentified image being substantially different from a second unidentified portion of the unidentified face in the second unidentified image;
a plurality of second pairs of identified images of identified faces, each second pair including a first identified image and a second identified image acquired simultaneously, and a first identified portion of the identified face in the first identified image being substantially different from a second identified portion of the identified face in the second identified image; and
means for comparing the pair of unidentified images with the plurality of pairs of identified images to determine a particular pair of identified images, which is substantially similar to the pair of unidentified images to identify the unidentified face.

2. The system of claim 1, further comprising:
means for normalizing each image to a scale based on an actual size of the face in the image.

3. The system of claim 1, in which the pair of unidentified images is acquired by a single camera, the first unidentified image acquired directly, and the second unidentified image acquired indirectly via a mirror.

4. The system of claim 1, in which the pair of unidentified images is acquired by two cameras having optical axes substantially perpendicular to each other.

5. The system of claim 1, in which the pairs of identified images are organized according to actual sizes of the identified faces, and the comparing is according to the actual sizes of the faces.

6. The system of claim 1, in which the pairs of identified images are organized according to actual sizes of features of the identified faces, and the comparing is according to the actual sizes of the features of the faces.

7. The system of claim 1, in which each first image is a frontal view and each second image is a profile side view.

8. A method for identifying a face, comprising:
acquiring simultaneously a first pair of unidentified images of an unidentified face, the first pair including a first unidentified image and a second unidentified image, and a first unidentified portion of the unidentified face in the first unidentified image being substantially different from a second unidentified portion of the unidentified face in the second unidentified image;
acquiring a plurality of second pairs of identified images of identified faces, each second pair including a first identified image and a second identified image acquired simultaneously, and a first identified portion of the identified face in the first identified image being substantially different from a second identified portion of the identified face in the second identified image; and
comparing the pair of unidentified images with the plurality of pairs of identified images to determine a particular pair of identified images, which is substantially similar to the pair of unidentified images to identify the unidentified face.

9. The method of claim 8, further comprising:
normalizing each image to a scale based on an actual size of the face in the image.

10. The method of claim 8, further comprising:
acquired the first unidentified image directly by a camera; and
acquiring the second unidentified image indirectly by the camera via a mirror.

11. The method of claim 8, in which the pair of unidentified images is acquired by two cameras having optical axes substantially perpendicular to each other.

12. The method of claim 8, further comprising:
organizing the pairs of identified images according to actual sizes of the identified faces, and the comparing is according to the actual sizes of the faces.

13. The method of claim 8, in which the pairs of identified images are organized according to actual sizes of features of the identified faces, and the comparing is according to the actual sizes of the features of the faces.

14. The method of claim 8, in which each first image is a frontal view and each second image is a profile side view.
